(19) United States
(12) Patent Application Publication
(10) Pub. No.: US 2003/0112385 A1
(43) Pub. Date: Jun. 19, 2003

(54) Liquid crystal display device

(75) Inventor: Kazuhiro Okamoto, Kawasaki (JP)

Correspondence Address: GREER, BURNS & CRAIN, 300 S WACKER DR, 25TH FLOOR, CHICAGO, IL, 60606, US

(73) Assignee: FUJITSU DISPLAY TECHNOLOGIES CORPORATION

(21) Appl. No.: 10/310,112

(22) Filed: Dec. 4, 2002

(30) Foreign Application Priority Data
Dec. 10, 2001 (JP) 2001-375694

(51) Int. Cl. G02F 1/1333

(52) U.S. Cl. 349/58

(57) ABSTRACT

A liquid crystal display device includes a liquid crystal panel and at least one attachment portion for attaching said liquid crystal panel to a receiving body. The attachment portion is provided with a variable mechanism for varying the mode of attaching the attachment portion to the receiving body.

### BACKGROUND OF THE INVENTION

1. Field of the Invention

The present invention relates to a liquid crystal display device and particularly relates to a liquid crystal display device provided with at least one attachment portion for attaching the liquid crystal display device to a receiving body such as an information-processing terminal apparatus.

2. Description of the Related Art

Recently, liquid crystal display devices are replacing display CRTs of information processing devices. Also, there is a need for supplying liquid crystal devices at a low price that is near the price of CRTs. Further, a wide variety of liquid crystal devices are now commercially available.

FIGS. 1 and 2 show a liquid crystal display device 1 of an example of the related art. FIG. 1 is a perspective diagram showing the liquid crystal display device 1 of the related art and FIG. 2 is a cross-sectional diagram of the liquid crystal display device 1 showing an attachment portion 5 in an enlarged view. The liquid crystal display 1 may be attached to and received by an electronic apparatus such as an information-processing device.

The liquid crystal display device 1 generally includes a liquid crystal panel 2, a housing 3 and a backlight unit (not shown in the figure). The liquid crystal panel 2 displays images thereon.

A light-conducting plate of the backlight unit (not shown) is provided on the backside of the liquid crystal panel 2. Light source parts are provided on either side of the light conducting plate. Light generated by the light source parts is incident on the light conducting plate, reflected a plurality of times in the light conducting plate and uniformly illuminates the liquid crystal panel 2.

The liquid crystal panel 2 and the backlight unit are provided in a housing 3 that serves as an overlay board. As shown in FIG. 2, the housing 3 comprises an upper housing 3a and a lower housing 3b.

Inside the housing 3, there is provided a frame 7 for supporting the liquid crystal panel 2 and the backlight unit. In FIG. 1, reference numeral 4 indicates a connector to be connected to an electronic apparatus. The connector is at least connected to the backlight unit.

In order to attach the above-described liquid crystal display device to an electronic apparatus, the attachment portions 5 provided on the housing 3 are fixed to predetermined attaching positions on the electronic apparatus. In detail, a fixing screw is inserted into an attaching through-hole 6 formed on the attaching part 5 and the fixing screw is screwed into a threaded through-hole formed at a predetermined attaching position of the electronic apparatus. In this manner, the liquid crystal device 1 is attached to the electronic apparatus.

It is to be noted that electronic apparatuses may come in various designs that may differ between various manufacturers of electronic apparatuses. In such a case where the designs of the electronic apparatuses are different, the attachment structure of the liquid crystal display device 1 will also be different between various electronic devices.

For example, in accordance with the design shown in FIG. 1, the attachment structure includes attachment portions 5 arranged on four corners of the housing 3. On the other hand, in order to attach a liquid crystal display device having the same liquid crystal panel 2, another electronic device may have a different design in which attachment positions are at central positions of the side parts of the housing. In this case, as shown by dash-dot lines in FIG. 1, attachment portions 5A must be provided at the central positions of the sides of the housing 3.

In the related art, attachment positions of the attachment portions 5 differ between electronic apparatuses of different designs. Therefore, it is necessary to manufacture various types of liquid crystal display devices 1 having attachment portions 5 of different designs that match the designs of the electronic apparatuses.

Accordingly, in the related art, even if the liquid panels 2 have the same design, it is necessary to manufacture various types of liquid crystal devices 1 to achieve attachment portions 5 of various designs. The need to manufacture various types of liquid crystal devices 1 causes an increase in development cost and thus an increase in the product cost.

It is also to be noted that a long period of time is required for developing the liquid crystal display device 1. Therefore, there is a problem that the development of the liquid crystal display device 1 inhibits early commercialization of electronic apparatuses, such as portable terminals, which have a short life cycle.

### SUMMARY OF THE INVENTION

Accordingly, it is a general object of the present invention to provide a liquid crystal display device that can obviate the problems described above.

It is another and more specific object of the present invention to provide a liquid crystal device with reduced product cost and shorter development period.

In order to achieve the above objects according to the present invention, a liquid crystal display device includes a liquid crystal panel and at least one attachment portion for attaching the liquid crystal panel to a receiving body. The attachment portion is provided with a variable mechanism for varying the mode of attaching the attachment portion to a receiving body.

According to the liquid crystal display device described above, the liquid crystal display device can be attached to various types of receiving bodies of different attaching positions and different attaching directions. Therefore, since it is no longer necessary to manufacture liquid crystal display devices each corresponding to a specific attachment mode adopted for attachment receiving parts of electronic apparatuses, the liquid crystal display device can be manufactured at a reduced cost.

### BRIEF DESCRIPTION OF THE DRAWINGS

FIG. 1 is a perspective diagram showing an example of a liquid crystal display device of the related art;

FIG. 2 is a cross-sectional diagram of the liquid crystal display device of the related art showing an attachment portion of the liquid crystal display device of the related art in an enlarged view;

FIG. 3 is a perspective diagram showing an attachment portion of the liquid crystal display device of an embodiment of the present invention in an enlarged view;

FIG. 4 is an exploded perspective view showing an attachment portion of the liquid crystal display device of an embodiment of the present invention in an enlarged view;

FIG. 5 is a cross-section diagram showing an attachment portion of the liquid crystal display device of an embodiment of the present invention in an enlarged view;

FIG. 6 is a perspective diagram showing an attachment portion of the liquid crystal display device of an embodiment of the present invention in an enlarged view with an opening of an attachment through-hole facing upward; and

FIG. 7 is a cross-sectional diagram showing an attachment portion of the liquid crystal display device of an embodiment of the present invention in an enlarged view with an opening of an attachment through-hole facing upward.

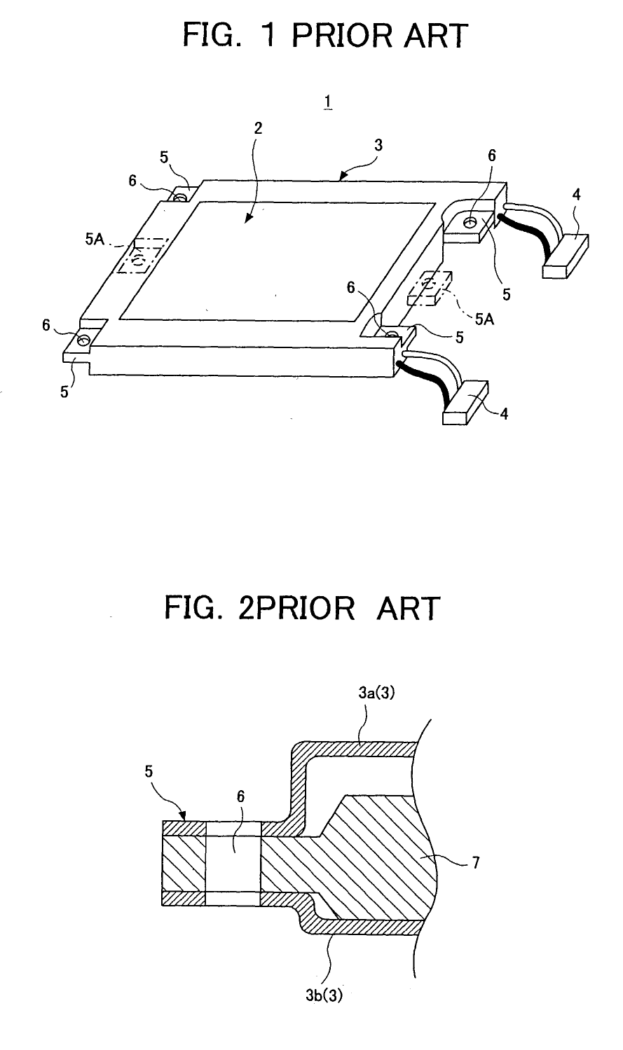

### DETAILED DESCRIPTION OF THE PREFERRED EMBODIMENTS

In the following, principles and embodiments of the present invention will be described with reference to the accompanying drawings.

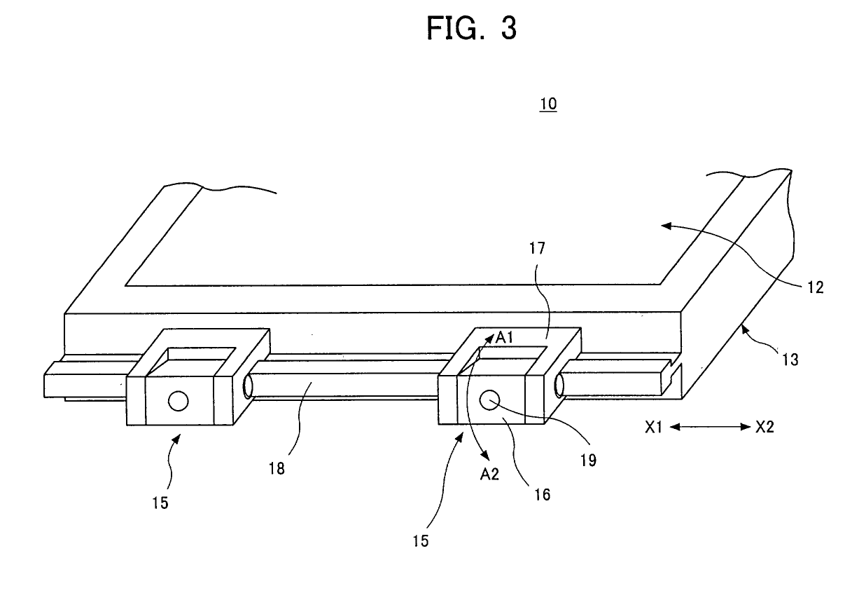

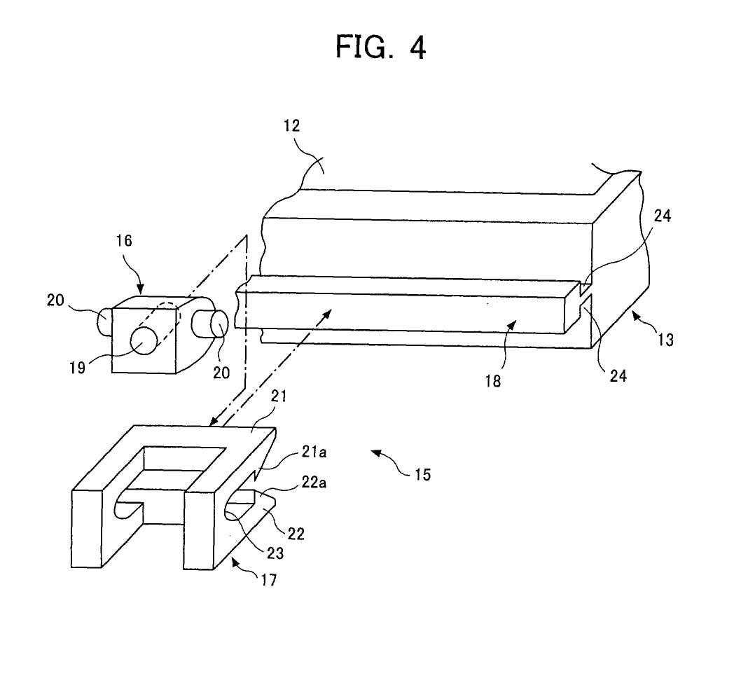

FIG. 3 is a perspective diagram showing essential parts of a liquid crystal display device 10 of an embodiment of the present invention. FIGS. 4 through 7 are diagrams used for explaining the structure and operation of a variable mechanism 15 of the liquid crystal display device 10.

The liquid crystal display device 10 generally includes a liquid crystal panel 12, a housing 13 and a backlight unit (not shown in the figure). The liquid crystal panel 12 displays images thereon. The backlight unit (not shown) is provided on the backside of the liquid crystal panel 12. The liquid crystal panel 2 and the backlight unit are provided in a housing 13 that serves as an overlay board. It is to be noted that the backlight apparatus may be one well-known in the art.

In order to attach the liquid crystal display device 10 having a structure described above to a receiving body, pivotable members 16, which serve as attachment portions, and receiving parts (not indicated) provided on the electronic apparatus are secured to each other.

In detail, the pivotable member 16 is provided with an attachment through-hole 19 configured as a threaded through-hole. A fixing screw is screwed through the receiving part of the electronic part and then screwed into the attachment through-hole 19. Thus, the pivotable member 16 and the receiving part of the electronic apparatus are secured. In this manner, the liquid crystal display device 10 is attached to the electronic apparatus.

In the present embodiment, the pivotable members 16 serving as the attachment portions are not fixed to the housing 13 and are displaceable against the housing 13 by means of the variable mechanism 15. As shown in an enlarged view of FIG. 4, the variable mechanism 15 includes a pivotable member 16, a slide member 17 and a guide rail 18.

The pivotable member 16 may be a resin molded item and is provided with an attachment through-hole 19 having an opening on one of the surfaces of the pivotable member 16 such that a fixing screw can be screwed therein. Also, a pair of shaft parts 20 is formed on opposing side surfaces of the pivotable member 16. The axial direction of the shaft part 20 is substantially orthogonal to the central line of the attaching through-hole 19.

The slide member 17 may be a resin molded item and has a cross-section as shown in FIG. 4 which has a rectangular shape with one of its sides being removed. In detail, the slide member 17 includes an upper arm part 21 having a detent 21a, a lower arm part 22 having a detent 22a and a bearing part 23 formed as a U-shaped groove between the arm parts 21 and 22. Each of the arm parts 21 and 22 are slightly deformable in a vertical direction in the figure.

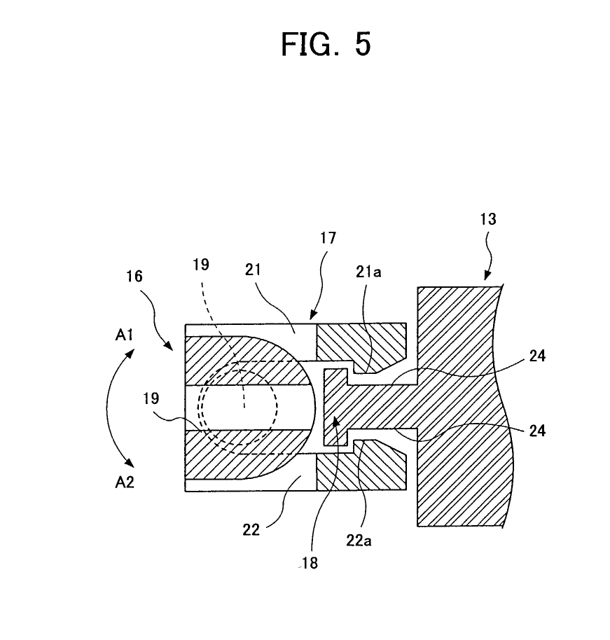

The pivotable member 16 is mounted on the bearing part 23 of the slide member 17. In the mounted state, the shaft parts 20 formed on the pivotable member 16 are pivotably journalled in the bearing part 23. Thus, the pivotable member 16 can be pivoted against the slide member 17 in directions shown by arrows A1 and A2 shown in FIGS. 3 and 5.

The guide rail 18 is formed on one of the side surfaces of the housing 13. The guide rail 18 is formed such that it extends along one of the side surfaces of the housing 13 in directions shown by arrows X1 and X2 in FIG. 3. Also, the guide rail 18 is provided with a pair of stepped parts 24 that are provided in a mutually opposing manner. The stepped parts 24 extend over the range in which the guide rail 18 is formed.

The slide member 17 is mounted on the guide rail 18 with the pivotable member 16 assembled thereto. In the mounted state, the detents 21a and 22a formed on the arm parts 21 and 22, respectively, engage with the stepped parts 24 formed on the guide rail 18 (see FIG. 5). With the detents 21a and 22a being engaged to the stepped parts 24 of the guide rail 18, the slide member 17 is slidable along the direction shown by the arrows X1 and X2 in FIG. 3 in such manner that the slide member 17 does not come off from the guide rail 18.

As has been described above, the liquid crystal display device 10 of the present embodiment is configured such that the pivotable member 16 is displaceable with respect to the housing 13 by means of the variable mechanism 15. Accordingly, the pivotable member 16 can conform to the design (attaching position and attaching direction) of the attachment receiving part of the electronic apparatus. Thus, the liquid crystal display device 10 can be attached to various electronic apparatuses having different attaching positions and different attaching directions. Therefore, since it is no longer necessary to manufacture a liquid crystal display device for each of the designs of the attachment receiving parts of the electronic apparatus, the liquid crystal display device 10 can be provided with reduced cost.

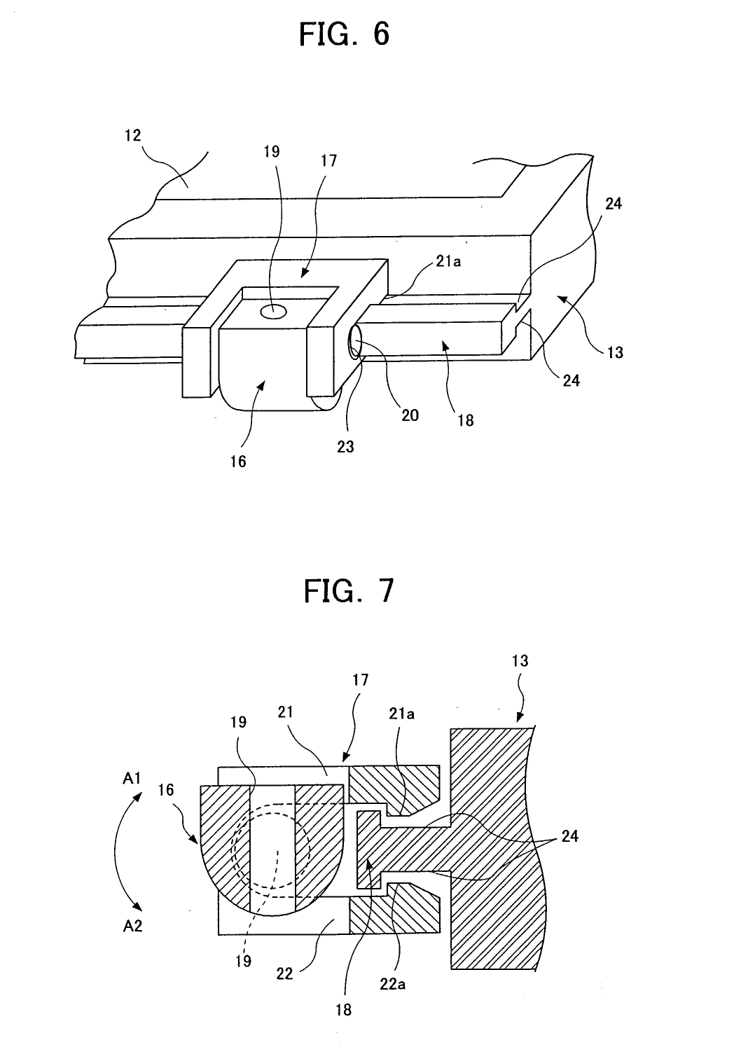

In detail, the direction of screwing a fixing screw into the attachment through-hole 19 can be altered by pivoting the pivotable member 16 in the directions shown by the arrows A1 and A2 in the figure. FIGS. 6 and 7 are similar to FIGS. 3 and 5 except that the pivotable member 16 is pivoted through approximately 90 degrees in the direction shown by the arrow A1 such that an opening of the attachment through-hole 19 faces upward. In this manner, the direction of the attachment through-hole 19 can be varied through any angle within a range of approximately 180 degrees.

Also, the position of the pivotable member 16 can be altered by displacing the slide member 17 in the directions shown by arrows X1 and X2 along the guide rail 18. Thus, the position of the attachment through-hole 19 can be adjusted to any position along the side surface of the housing 13. Further, since the slide member 17 is removably mounted on the guide rail 18, any number of pivotable members 16 can be mounted on the guide rail.

For example, in the embodiment shown in FIG. 3, two variable mechanisms (slide members 17) are provided to secure the pivotable members 16 and the electronic apparatus at two positions. However, one of the variable mechanisms 15 (slide member 17) may be removed such that the pivotable member 16 and the electronic apparatus are secured at a single position.

Further, a plurality of variable mechanisms 15 (slide members 17) may be mounted on the guide rail 18 such that the pivotable members 16 and the electronic apparatus are secured at three or more positions. Thus, according to the liquid crystal display device 10 of the present embodiment, any number and positions of the pivotable members 16 serving as the attachment portions can be chosen. Accordingly, the liquid crystal device of the present invention can conform to various designs of attachment receiving parts of the electronic apparatuses.

Further, the present invention is not limited to these embodiments, and variations and modifications may be made without departing from the scope of the present invention.

The present application is based on Japanese priority application No. 2001-375694 filed on Dec. 10, 2001, the entire contents of which are hereby incorporated by reference.

What is claimed is:

1. A liquid crystal display device comprising:
a liquid crystal panel; and
at least one attachment portion for attaching said liquid crystal panel to a receiving body;
wherein said attachment portion is provided with a variable mechanism for varying a mode of attaching said attachment portion to said receiving body.

2. The liquid crystal display device as claimed in claim 1, wherein said variable mechanism is capable of varying an attachment direction for attaching said attachment portion to said receiving body.

3. The liquid crystal display device as claimed in claim 1, wherein said variable mechanism is capable of displacing an attachment position for attaching of said attachment portion to said receiving body.

4. The liquid crystal display device as claimed in claim 1, wherein said variable mechanism is configured such that said attachment portion is pivotable.

5. The liquid crystal display device as claimed in claim 1, wherein said variable mechanism is configured such that said attachment portion is slidable along one of peripheral side surfaces of said liquid crystal panel.
